(19) United States
(12) Patent Application Publication
(10) Pub. No.: US 2022/0204362 A1
(43) Pub. Date: Jun. 30, 2022

(54) APPARATUS AND METHOD FOR CONTROLLING WATER SOFTENERS

(71) Applicant: KYUNGDONG NAVIEN CO., LTD., Gyeonggi-do (KR)

(72) Inventor: Dong Myun CHO, Seoul (KR)

(73) Assignee: KYUNGDONG NAVIEN CO., LTD., Gyeonggi-do (KR)

(21) Appl. No.: 17/559,195

(22) Filed: Dec. 22, 2021

(30) Foreign Application Priority Data
Dec. 29, 2020 (KR) 10-2020-0186357
Dec. 13, 2021 (KR) 10-2021-0178061

(51) Int. Cl. C02F 1/00; C02F 1/469; C02F 5/00

(52) U.S. Cl. CPC C02F 1/008; C02F 1/4691; C02F 5/00; C02F 2209/40; C02F 2209/10; C02F 2201/46145; C02F 2209/44; C02F 2201/4615

(57) ABSTRACT

Disclosed is an apparatus for controlling water softeners includes a first water softener that softens and recycles source water, a second water softener that softens and recycles mutually complementarily with the first water softener, and a controller that controls water softening and recycling of the first water softener and the second water softener, based on water softening capabilities of the first water softener and the second water softener.

### CROSS-REFERENCE TO RELATED APPLICATION

This application claims the benefit of priority to Korean Patent Application No. 10-2020-0186357 and 10-2021-0178061, filed in the Korean Intellectual Property Office on Dec. 29, 2020 and Dec. 13, 2021, respectively, the entire contents of which are incorporated herein by reference.

### TECHNICAL FIELD

The present disclosure relates to an apparatus and a method for controlling water softeners.

### BACKGROUND

A water softener is a device that generates soft water by filtering hard water with an ion exchanger resin and a filter and removing hard substances (calcium, magnesium, and the like) contained therein. Factors that influence an operation efficiency of the water softener include a pressure and a quality of introduced water, a power consumption, and the like. Accordingly, the operation efficiency of the water softener may be changed according to an area and an environment, in which the water softener is installed. That is, a control has to be made in an operation scheme that is suitable for an installation area/environment of the water softener.

A conventional water softener is one capacitive deionization (CDI) module, and the softened water is preserved in a tank and is supplied to a user if necessary. However, according to the water softening scheme, germs and foreign substances are generated as the softened water is preserved in a water tank for a long period of time.

Furthermore, when one CDI module is used, it has to be used again after standing by until recycling is performed again when the capability of the CDI module is exceeded, and thus the procedure is bothersome and much time is taken for the water softening operation.

### SUMMARY

The present disclosure has been made to solve the above-mentioned problems occurring in the prior art while advantages achieved by the prior art are maintained intact.

An aspect of the present disclosure provides an apparatus and a method for controlling water softeners, by which a user may be continuously provided with softened water by alternately performing water softening and recycling by a plurality of water softeners.

An aspect of the present disclosure provides an apparatus and a method for controlling water softeners, by which water softening and recycling that are optimized for capabilities of water softeners by performing water softening and recycling based on capabilities of the water softeners may be implemented, and life spans of the water softeners may be secured.

An aspect of the present disclosure provides an apparatus and a method for controlling water softeners, by which life spans of the CDI module may become uniform by performing water softening by a CDI module that finishes recycling first.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for controlling water softeners includes a first water softener that softens and recycles source water, a second water softener that softens and recycles mutually complementarily with the first water softener, and a controller that controls water softening and recycling of the first water softener and the second water softener, based on water softening capabilities of the first water softener and the second water softener.

According to an embodiment, the controller may control the second water softener to perform water softening when the capability of the first water softener is less than a first preset reference value.

According to an embodiment, the controller may control the first water softener to perform recycling when the capability of the first water softener is less than the first preset reference value.

According to an embodiment, the controller may control the first water softener to perform recycling after preset time has elapsed when the capability of the first water softener is the first preset reference value or more and less than a second preset reference value.

According to an embodiment, the controller may control the first water softener to continue to perform water softening during next use of water when the capability of the first water softener is not less than the second preset reference value.

According to an embodiment, the controller may perform a control to finish recycling even though use of water is stopped, when at least one of the first water softener and the second water softener performs recycling.

According to an embodiment, the controller may control, among the first water softener and the second water softener, a water softener that finishes recycling first to perform water softening.

According to an embodiment, the first water softener and the second water softener may perform the water softening and recycling in a capacitive deionization scheme.

According to an embodiment, the capabilities of the first water softener and the second water softener may be values calculated based on a total dissolved solid (TDS) concentration and a flow rate of the source water.

According to an aspect of the present disclosure, a method for controlling a first water softener that softens and recycles source water and a second water softener that to softens and recycles mutually complementarily with the first water softener may controlling water softening and recycling of the first water softener and the second water softener, based on water softening capabilities of the first water softener and the second water softener.

According to an embodiment, the controlling of the water softening and recycling of the first water softener and the second water softener may include controlling the second water softener to perform water softening when the capability of the first water softener is less than a first preset reference value.

According to an embodiment, the controlling of the water softening and recycling of the first water softener and the second water softener may include controlling the first water softener to perform recycling when the capability of the first water softener is less than the first preset reference value.

According to an embodiment, the controlling of the water softening and recycling of the first water softener and the second water softener may include controlling the first water softener to perform recycling after preset time has elapsed when the capability of the first water softener is the first preset reference value or more and less than a second preset reference value.

According to an embodiment, the controlling of the water softening and recycling of the first water softener and the second water softener may include controlling the first water softener to continue to perform water softening during next use of water when the capability of the first water softener is not less than the second preset reference value.

According to an embodiment, the controlling of the water softening and recycling of the first water softener and the second water softener may include performing a control to finish recycling even though use of water is stopped, when at least one of the first water softener and the second water softener performs recycling.

According to an embodiment, the controlling of the water softening and recycling of the first water softener and the second water softener may include controlling, among the first water softener and the second water softener, a water softener that finishes recycling first to perform water softening.

### BRIEF DESCRIPTION OF THE DRAWINGS

The above and other objects, features and advantages of the present disclosure will be more apparent from the following detailed description taken in conjunction with the accompanying drawings:

FIG. 1 is a conceptual view illustrating a principle of removing ions in a CDI scheme;

FIG. 2 is a conceptual view illustrating a principle of recycling an electrode in a CDI scheme;

FIG. 3 is a block diagram illustrating a configuration of an apparatus for controlling a water softener according to an embodiment of the present disclosure;

FIG. 4 is a view illustrating a structure of a water softening system including an apparatus for controlling a water softener according to an embodiment of the present disclosure;

FIG. 5 is a flowchart illustrating a method for controlling a water softener according to an embodiment of the present disclosure; and

FIG. 6 is a block diagram illustrating a configuration of a computing device that performs a method for controlling a water softener according to an embodiment of the present disclosure.

### DETAILED DESCRIPTION

Hereinafter, various embodiments disclosed in the present disclosure will be described in detail with reference to the accompanying drawings. The same elements on the drawings of the present disclosure will be denoted by the same reference numerals, and a repeated description thereof will be omitted.

In various embodiments of the present disclosure, specific structural and functional descriptions are simply exemplified for the purpose of explaining the embodiments, and the various embodiments of the present disclosure may be carried out in various forms and it should not be construed that the present disclosure is limited to the described embodiments.

The terms, such as “first”, “second”, and the like used herein may refer to various elements of various embodiments of the present disclosure, but do not limit the elements. For example, such terms do not limit the order and/or priority of the elements. For example, without departing the scope of the disclosure, a first element may be referred to as a second element, and similarly, a second element may be referred to as a first element.

Terms used in this specification are used to describe specified embodiments of the present disclosure and are not intended to limit the scope of the disclosure. The terms of a singular form may include plural forms unless otherwise specified.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined herein in various embodiments of the present disclosure. According to occasions, even a term defined in the present disclosure cannot be construed to exclude the embodiments of the present disclosure.

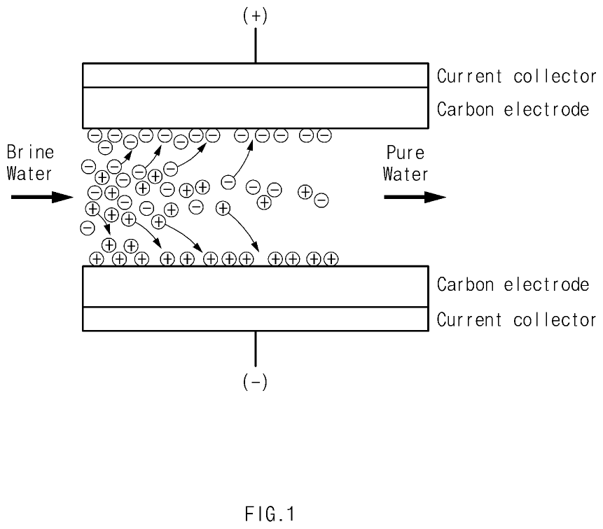

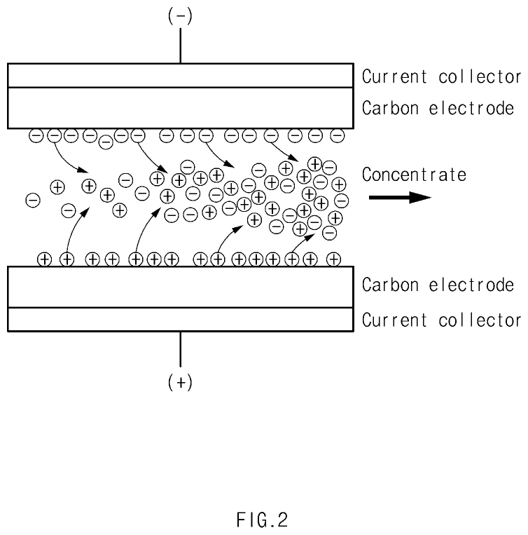

FIG. 1 is a conceptual view illustrating a principle of removing ions in, among electrical deionization schemes, a CDI scheme. FIG. 2 is a conceptual view illustrating a principle of recycling an electrode in a CDI scheme.

When a DC voltage is applied to charged particles in an electrolyte, positive charged particles flow to a negative electrode and negative charged particles flow to a positive electrode. This is called electrophoresis. An electrical deionization scheme refers to a scheme of selectively removing ions (ionic materials) in water based on a principle of an electric force (electrophoresis).

The electrical deionization scheme includes schemes, such as electrodialysis (ED), Electro deionization (EDI), continuous electro deionization (CEDI), and capacitive deionization (CDI). A filter unit in the ED scheme includes electrodes and an ion exchange membrane. A filter unit in the EDI scheme includes electrodes, an ion exchange membrane, and an ion exchange resin. A filter unit in the CDI scheme includes only electrodes, or includes electrodes and an ion exchange membrane.

The filter unit according to the embodiment of the present disclosure may remove the ionic material in, among the electrical deionization schemes, the capacitive deionization (CDI) scheme. The CDI scheme refers to a scheme of removing ions by using a principle of adsorbing and desorbing ions or ionic materials to and from a surface of an electrode with an electrical force.

In the water softener according to the embodiment of the present disclosure, a case in which the ionic materials are removed in, among the electrical deionization schemes, the capacitive deionization (CDI) scheme, will be exemplified. However, this is a simple example, and the water softener according to the present disclosure is not limited to the CDI scheme, and as described above, various electrical deionization schemes may be applied to the water softener according to the embodiment of the present disclosure.

Generally, the CDI scheme refers to a scheme of removing ions by using a principle of adsorbing and desorbing ions or ionic materials to and from a surface of an electrode with an electrical force.

Referring to FIG. 1, when source water including ions passes between the electrodes in a state in which a voltage (for example, +300 V) is applied to electrodes, negative ions flow to a positive electrode and positive ions flow to a negative electrode. That is, adsorption occurs. Due to the adsorption, ions in the source water may be removed. A mode of removing ions or ionic materials in this way is referred to as a removal mode.

However, adsorption capabilities of the electrodes are limited. Accordingly, when adsorption continues, the electrodes reach a state, in which ions cannot be adsorbed any more. To prevent this, as illustrated in FIG. 2, it is necessary to desorb the ions adsorbed to the electrode to recycle the electrodes. To achieve this, an opposite voltage (for example, −300 V, −5V or other voltage) to that of the removal mode may be applied to the electrodes or no voltage may be applied. In this way, a mode of recycling electrodes is referred to as a recycling mode. The recycling mode may be performed before or after the removal mode, and a time interval between the recycling mode and the removal mode may be variously set.

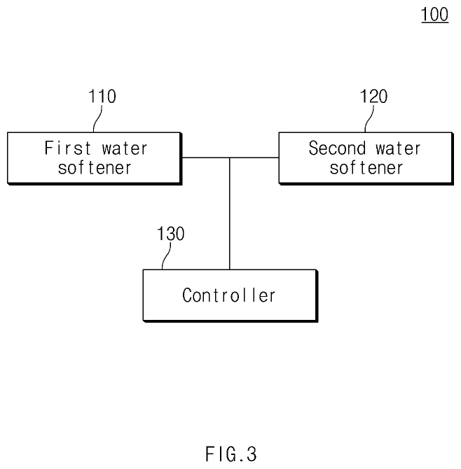

FIG. 3 is a block diagram illustrating a configuration of an apparatus for controlling a water softener according to an embodiment of the present disclosure.

Referring to FIG. 3, an apparatus 100 for controlling water softeners according to an embodiment of the present disclosure may include a first water softener 110, a second water softener 120 and a controller 130.

The first water softener 110 may soften and recycle source water. Furthermore, the second water softener 120 may perform water softening and recycling mutually complementarily with the first water softener 110. That is, the first water softener 110 and the second water softener 120 may repeat water softening and recycling and may provide the softened water to a user. Then, the first water softener 110 and the second water softener 120 may include a CDI module that performs water softening and recycling in the CDI scheme.

In detail, the second water softener 120 may perform recycling while the first water softener 110 softens the source water. Alternatively, when a capability of the first water softener 110 becomes lack and recycling is required, the first water softener 110 may perform recycling and the second water softener 120 that finishes recycling may perform water softening. In this way, in the apparatus 100 for controlling water softeners according to an embodiment of the present disclosure, the first water softener 110 and the second water softener 120 may alternately perform water softening and recycling. Accordingly, the user may be continuously provided with softened water while the quality of the water is not changed.

The controller 130 may control water softening and recycling of the first water softener 110 and the second water softener 120 based on water softening capabilities of the first water softener 110 and the second water softener 120. For example, the capabilities of the first water softener 110 and the second water softener 120 may be values that represent amount of ions or ionic materials that may be absorbed in the electrodes included in the first water softener 110 and the second water softener 120.

In detail, the controller 130 may control the second water softener 120 to perform water softening instead of the first water softener 110 when the capability of the first water softener 110 is decreased to less than a preset reference value as the water softening is performed. Then, the controller 130 may control the first water softener 110 to perform recycling.

For example, when the capability of the first water softener 110 left after water is completely used after the first water softener 110 performs water softening due to a request for use of water by the user is less than 50%, the controller 130 may control the first water softener 110 to enter the recycling mode and then, may control the second water softener 120 to perform water softening instead when use of water is required. Furthermore, when the capability of the first water softener 110 becomes 0% during use of water while the first water softener 110 performs water softening according to a request of use of water by the user, the controller 130 may immediately replace the second water softener 120 to allow the second water softener 120 to perform water softening, and may control the first water softener 110 to start recycling.

The controller 130 may control the first water softener 110 to continue to perform water softening during next use of water when the remaining capability of the first water softener 110 after the water is completely used is more than the above-described reference value (for example, 50% of the total capability).

For example, the controller 130 may control the first water softener 110 to perform recycling and to stand by until a request for use of water is made when the remaining capability of the first water softener 110 after the water is completely used is more than a first reference value (50% of the total capability).

Also, the controller 130 may control the first water softener 110 to perform recycling and to stand by until a request for use of water is made after preset time (for example, 30 minutes) has elapsed from the time that the water is completely used when the remaining capability of the first water softener is the first preset reference value (50% of total capability) or more and less than a second preset reference value (80% of total capability).

Also, the controller 130 may control the first water softener 110 to stand by until a request for use of water is made when the remaining capability of the first water softener is not less than the second preset reference value (80% of total capability.

Furthermore, the controller 130 may control at least one of the first water softener 110 and the second water softener 120 to finish recycling even though use of the water is stopped when the at least one of the first water softener 110 and the second water softener 120 performs recycling. In this case, the controller 130 may control, among the first water softener 110 and the second water softener 120, the water softener that finishes recycling first to perform water softening. Accordingly, a life span of the water softener may become uniform so that durability may be secured.

Meanwhile, the capabilities of the first water softener 110 and the second water softener 120 may be calculated based on a table, in which data measured by various sensors, such as TDS sensors 16a and 16b and a flow rate sensing sensor 34, of a water softening system 10 including the apparatus 100 for controlling a water softener and the capabilities of the first water softener 110 and the second water softener 120 are matched and stored.

Meanwhile, FIG. 3 illustrates that the apparatus 100 for controlling a water softener according to the embodiment of the present disclosure includes two water softeners 110 and 120, but the present disclosure is not limited thereto, and the number of the water softeners may be variously determined according to necessity, and a scheme of controlling the water softeners or the number of the water softeners may be changed.

In this way, the apparatus for controlling a water softener according to the embodiment of the present disclosure may continuously provide softened water to the user by controlling the plurality of water softeners to alternately perform water softening and recycling.

Furthermore, the apparatus for controlling water softeners according to the embodiment of the present disclosure may implement water softening and recycling optimized for the capabilities of the water softeners by performing water softening and recycling based on the capabilities of the water softeners instead of a conventional method of controlling water softening with reference to a water softening time, and may secure life spans of the water softeners.

Furthermore, the apparatus for controlling water softeners according to the embodiment of the present disclosure may make the life spans of the CDI modules uniform by controlling a CDI module that finishes recycling first to perform water softening.

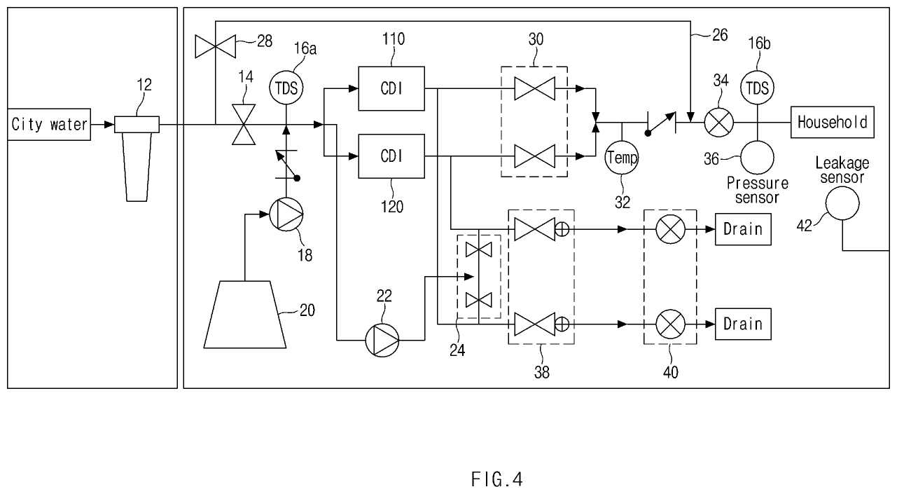

FIG. 4 is a view illustrating a structure of a water softening system including an apparatus for controlling a water softener according to an embodiment of the present disclosure.

Referring to FIG. 4, the water softening system 10 may include a sediment filter 12, a main solenoid valve 14, the total dissolved solid sensors 16a and 16b, a CIP pump 18, a citric acid tank 20, a circulation pump 22, a circulation solenoid valve 24, a bypass line 26, a bypass solenoid valve 28, a water softening solenoid valve 30, a temperature sensor 32, a flow rate sensor 34, a pressure sensor 36, a recycling solenoid valve 38, a recycling water sensing sensor 40, and a leakage sensor 42.

In detail, the water softening system 10 according to the embodiment of the present disclosure deposits and removes foreign substance particles that are present in the source water in the sediment filter 12 when the source water is supplied from city water first. Furthermore, when the main solenoid valve 14 is opened, the source water flows into the water softeners 110 and 120. Then, the TDS sensor 16a detects a total dissolved solid (TDS) concentration of the source water before primary water softening.

Furthermore, the source water may be softened by the first water softener 110 and the second water softener 120. For example, when the first water softener 110 performs water softening, the source water may be softened by the first water softener 110 and may be supplied to a household via the water softening solenoid valve 30. Then, the temperature sensor 32 may measure a temperature of the softened water to diagnose whether a pipeline is frozen to burst or such that the temperature is utilized when the TDS is calculated.

The flow rate sensor 34 may measure a flow rate of the softened water such that water softening times and voltages of the water softeners 110 and 120 may be controlled. Furthermore, the TDS sensor 16b may detect a total dissolved solid concentration of the softened water such that it is determined whether the water softening is normally performed, and the pressure sensor 36 may measure pressure such that it may be diagnosed whether a pipeline is abnormally blocked.

Meanwhile, when the first water softener 110 performs water softening, the second water softener 120 may perform recycling unless the second water softener 120 is in a recycling completion state. Then, the water softening solenoid valve 30 that is close to the second water softener 120 is closed, and the recycled water recycled by the second water softener 120 may flow to an outside of the water softening system 10 via the recycling solenoid valve 38 and a reducing ring. Then, it may be detected by the recycling water sensing sensor 40 whether the recycled water is discharged.

Furthermore, a water softening process in the above-described water softening system 10 may be performed in a similar way even when the second water softener 120 performs water softening. That is, when the second water softener 120 performs water softening, on the contrary, the first water softener 110 may perform recycling.

Furthermore, when water softening apparatuses and pipelines including the first water softener 110 and the second water softener 120 of the water softening system 10 are washed, a citric acid solution may be supplied into the system from the citric acid tank 20 by using the CIP pump 18. For example, the citric acid tank 20 may supply the citric acid solution in a time set by the user. Then, because the supplied citric acid solution may circulate via the circulation solenoid valve 24 by the circulation pump 22, washing may be performed by supplying the citric acid solution to the apparatuses and the pipelines in the water softening system 10. Meanwhile, FIG. 4 is illustrated based on the citric acid tank 20, but the water softening system 10 according to the embodiment of the present disclosure may use various solutions that may wash the water softening apparatuses and pipelines, in addition to the citric acid solution.

In a situation, in which the water softening apparatus cannot be used, such as when a water softening apparatus (for example, the water softener 110 or 120 or the water softening solenoid valve 30) of the water softening system 10 is washed or the water softening apparatus breaks down (for example, the leakage sensor 42 detects a leakage), the source water may be supplied to the bypass line 26 through the bypass solenoid valve 28. Then, the user may use the source water that is filtered through deposition until the water softening apparatus is completely washed or the breakdown of the water softening apparatus is repaired.

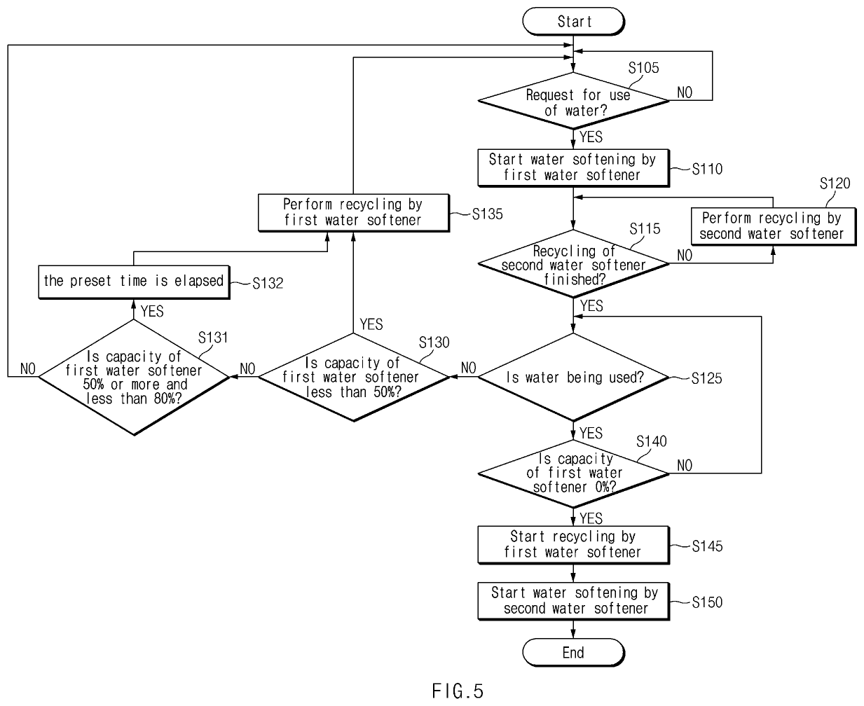

FIG. 5 is a flowchart illustrating a method for controlling a water softener according to an embodiment of the present disclosure.

Referring to FIG. 5, a method for controlling water softeners according to an embodiment of the present disclosure may be performed by a first water softener, and a second water softener that performs water softening and recycling mutually complementarily with the first water softener. Then, the first water softener and the second water softener may include a CDI module that performs water softening and recycling in the CDI scheme.

In detail, first, when a request for use of water is made by the user (S105) (YES), source water may be softened by the first water softener (S110). Then, when the second water softener does not finish recycling (S115) (NO), the second water softener may perform recycling (S120).

Further, it is identified whether water is currently used in operation S125, and when use of the water is stopped by the user (NO), it is determined whether a capability of the first water softener is less than 50% (S130).

When the capability of the first water softener is less than 50% (YES), the first water softener enters a recycling mode before a request for use of water is made again (S135). In this case, when operation S105 is performed and a request for use of water is made while standing by until a request for use of water is made, water softening may be started by the second water softener that finishes the recycling first.

Meanwhile, when the capability of the first water softener is not less than 50% (NO), it is determined whether the capability of the first water softener is 50% or more and less than 80% (S131).

At this time, when the capability of the first water softener is 50% or more and less than 80% (YES), the first water softener stands by until preset time (for example, 30 minutes) has elapsed from the time that the water is completely used and enters the recycling mode (S135). Also, when the capability of the first water softener is not less than 80% (NO), the first water softener stands by until a request for use of water is made by performing operation S105.

Meanwhile, when the user continues to use the water in operation S125 (YES), it is determined whether the capability of the first water softener becomes 0% (S140). When the capability of the first water softener becomes 0% as the water softening is performed by the first water softener (S140) (YES), the first water softener may stop the water softening operation and may enter a recycling mode (S145). Furthermore, the second water softener may perform a water softening operation instead of the first water softener (S150). For example, the capabilities of the first water softener 110 and the second water softener 120 may be calculated based on a table, in which data measured by various sensors, such as TDS sensors and a flow rate sensing sensor, of the water softening system 10 are matched in advance and the matching result is stored.

Furthermore, when the second water softener performs a water softening operation in operation S150, the second water softener may perform operations S110 to S140, which have been described above, in the same scheme as that of the first water softener. That is, in this case, in operations S110 to S140, the second water softener may perform a water softening operation, and the first water softener may perform a recycling operation.

When the capability of the first water softener is larger than 0% when the user is used in operation S140, the first water softener that has been being used already may be made to continue to perform the water softening operation. Furthermore, in the method for controlling water softeners according to the embodiment of the present disclosure, at least one of the first water softener 110 and the second water softener 120 may be controlled to finish recycling even though use of the water is stopped when the at least one of the first water softener 110 and the second water softener 120 performs recycling. In this case, among the first water softener 110 and the second water softener 120, the water softener that finishes recycling first may be controlled to perform water softening. Accordingly, a life span of the water softener may become uniform so that durability may be secured.

Meanwhile, although FIG. 5 illustrates that the first water softener starts water softening, the method for controlling water softeners according to the present disclosure is not limited thereto, and the second water softener may start water softening first and the first water softener may perform recycling. Furthermore, in the method for controlling water softeners according to the present disclosure, the number of the water softeners may be variously determined according to necessity, and the scheme of controlling the water softeners also may be changed according to the number of the water softeners.

In this way, the method for controlling a water softener according to the embodiment of the present disclosure may continuously provide softened water to the user by controlling the plurality of water softeners to alternately perform water softening and recycling.

Furthermore, the method for controlling water softeners according to the embodiment of the present disclosure may implement water softening and recycling optimized for the capabilities of the water softeners by performing water softening and recycling based on the capabilities of the water softeners instead of a conventional method of controlling water softening with reference to a water softening time, and may secure life spans of the water softeners.

Furthermore, the method for controlling water softeners according to the embodiment of the present disclosure may make the life spans of the CDI modules uniform by controlling a CDI module that finishes recycling first to perform water softening.

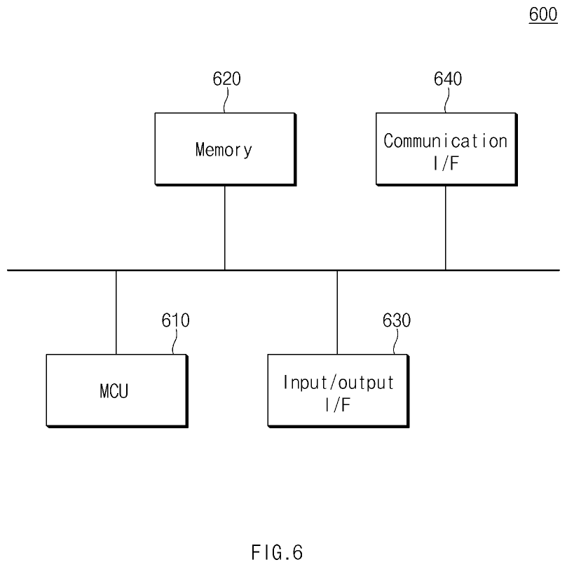

FIG. 6 is a block diagram illustrating a configuration of a computing device that performs a method for controlling a water softener according to an embodiment of the present disclosure.

Referring to FIG. 6, a computing system 600 according to an embodiment of the present disclosure may include an MCU 610, a memory 620, an input/output I/F 630, and a communication I/F 640.

The MCU 610 may be a processor that executes various programs (for example, a capability detecting program and a water softener control program) stored in the memory 620, processes various data, such as the capabilities of the water softeners and a flow rate of the water, through the programs, and performs functions of the apparatus for controlling water softeners illustrated in FIG. 3, which has been described.

The memory 620 may store various programs regarding detection of the capabilities of the water softeners and control of the water softeners. Furthermore, the memory 620 may store various data, such as the capabilities of the water softeners, the flow rate, and the water softening time.

A plurality of memories 620 may be provided according to necessities. The memory 620 may include a volatile memory or may be a nonvolatile memory. The memory 620 as a volatile memory may be a RAM, a DRAM, or an SRAM. The memory 620 as a nonvolatile memory may be a ROM, a PROM, an EAROM, an EPROM, an EEPROM, and a flash memory. The listed memories 620 are simple examples, and are not limited to the examples.

The input/output I/F 630 may provide an interface that connects an input device (not illustrated), such as a keyboard, a mouse, or a touch panel, and an output device, such as a display (not illustrated), and the MCU 610 to transmit and receive data.

The communication I/F 640 has a configuration that may transmit and receive various data to and from a server, and may be various devices that may support wired or wireless communication. For example, the communication I/F 640 may transmit and receive programs for detection of the capabilities of the water softeners and control of water softening, or various data, such as the flow rate and the water softening time, to and from a separately provided external server.

In this way, the computer program according to the embodiment of the present disclosure may be recorded in the memory 620, and may be processed by the MCU 610 to be implemented as a module that performs various functions illustrated in FIG. 3 as an example.

Although it may have been described until now that all the elements constituting the embodiments of the present disclosure are coupled to one or coupled to be operated, the present disclosure is not essentially limited to the embodiments. That is, without departing from the purpose of the present disclosure, all the elements may be selectively coupled into one or more elements to be operated.

Furthermore, because the terms, such as “comprising”, “including”, or “having” may mean that the corresponding element may be included unless there is a specially contradictory description, it should be construed that another element is not extruded but may be further included. In addition, unless defined otherwise, all terms used herein, including technical or scientific terms, have the same meanings as those generally understood by those skilled in the art to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

According to an embodiment of the present disclosure, softened water may be continuously provided to a user by controlling the plurality of water softeners to alternately perform water softening and recycling.

Furthermore, according to an embodiment of the present disclosure, water softening and recycling that are optimized for capabilities of water softeners by performing water softening and recycling based on capabilities of the water softeners may be implemented, and life spans of the water softeners may be secured.

In addition, according to an embodiment, life spans of the CDI module may become uniform by performing water softening by a CDI module that finishes recycling first.

The above description is a simple exemplification of the technical spirits of the present disclosure, and the present disclosure may be variously corrected and modified by those skilled in the art to which the present disclosure pertains without departing from the essential features of the present disclosure. Accordingly, the embodiments disclosed in the present disclosure is not provided to limit the technical spirits of the present disclosure but provided to describe the present disclosure, and the scope of the technical spirits of the present disclosure is not limited by the embodiments. Accordingly, the genuine technical scope of the present disclosure should be construed by the attached claims, and all the technical spirits within the equivalent ranges fall within the scope of the present disclosure.

What is claimed is:

1. An apparatus for controlling water softeners, the apparatus comprising:
a first water softener configured to soften and recycle source water;
a second water softener configured to soften and recycle mutually complementarily with the first water softener; and
a controller configured to control water softening and recycling of the first water softener and the second water softener, based on water softening capabilities of the first water softener and the second water softener.

2. The apparatus of claim 1, wherein the controller is configured to:
control the second water softener to perform water softening when the capability of the first water softener is less than a first preset reference value.

3. The apparatus of claim 2, wherein the controller is configured to:
control the first water softener to perform recycling when the capability of the first water softener is less than the first preset reference value.

4. The apparatus of claim 3, wherein the controller is configured to:
control the first water softener to perform recycling after preset time has elapsed when the capability of the first water softener is the first preset reference value or more and less than a second preset reference value.

5. The apparatus of claim 4, wherein the controller is configured to:
control the first water softener to continue to perform water softening during next use of water when the capability of the first water softener is not less than the second preset reference value.

6. The apparatus of claim 1, wherein the controller is configured to:
perform a control to finish recycling even though use of water is stopped, when at least one of the first water softener and the second water softener performs recycling.

7. The apparatus of claim 1, wherein the controller is configured to:
control, among the first water softener and the second water softener, a water softener that finishes recycling first to perform water softening.

8. The apparatus of claim 1, wherein the first water softener and the second water softener perform the water softening and recycling in a capacitive deionization scheme.

9. The apparatus of claim 1, wherein the capabilities of the first water softener and the second water softener are values calculated based on a total dissolved solid (TDS) concentration and a flow rate of the source water.

10. A method for controlling a first water softener configured to soften and recycle source water and a second water softener configured to soften and recycle mutually complementarily with the first water softener, the method comprising:
controlling water softening and recycling of the first water softener and the second water softener, based on water softening capabilities of the first water softener and the second water softener.

11. The method of claim 9, wherein the controlling of the water softening and recycling of the first water softener and the second water softener includes:
controlling the second water softener to perform water softening when the capability of the first water softener is less than first preset reference value.

12. The method of claim 11, wherein the controlling of the water softening and recycling of the first water softener and the second water softener includes:
controlling the first water softener to perform recycling when the capability of the first water softener is less than the first preset reference value.

13. The method of claim 12, wherein the controlling of the water softening and recycling of the first water softener and the second water softener includes:
controlling the first water softener to perform recycling after preset time has elapsed when the capability of the first water softener is the first preset reference value or more and less than a second preset reference value.

14. The method of claim 13, wherein the controlling of the water softening and recycling of the first water softener and the second water softener includes:
controlling the first water softener to continue to perform water softening during next use of water when the capability of the first water softener is not less than the second preset reference value.

15. The method of claim 10, wherein the controlling of the water softening and recycling of the first water softener and the second water softener includes:
performing a control to finish recycling even though use of water is stopped, when at least one of the first water softener and the second water softener performs recycling.

16. The method of claim 10, wherein the controlling of the water softening and recycling of the first water softener and the second water softener includes:
controlling, among the first water softener and the second water softener, a water softener that finishes recycling first to perform water softening.
